(19) United States
(12) Patent Application Publication
(10) Pub. No.: US 2016/0300292 A1
(43) Pub. Date: Oct. 13, 2016

(54) PRODUCT NAVIGATION TOOL

(71) Applicant: Twiggle Ltd., Tel-Aviv (IL)

(72) Inventors: Omri SHACHAM, Tel-Aviv (IL); Adi AVIDOR, Tel-Aviv (IL); Amir KONIGSBERG, Tel-Aviv (IL)

(21) Appl. No.: 14/681,194

(22) Filed: Apr. 8, 2015

(51) Int. Cl. G06Q 30/06

(52) U.S. Cl. CPC G06Q 30/0643; G06Q 30/0625; G06Q 30/0631

(57) ABSTRACT

A method for updating an interactive product navigation user interface that comprises performing interface updating iterations, during iteration, send instructions to an application running on a client terminal to present an interactive product navigation user interface with an interactive indication, receive a user selection of the interactive indication from the application, select a product as a currently selected product according to the user selection, receive at least one reference product characteristic from product characteristics of the currently selected product, and update the interactive product navigation user interface with at least one new interactive indication of at least one member of at least one recommended product, the at least one member is selected according to a similarity between a characteristic value of the reference product characteristic of the currently selected product and a respective characteristic value of the reference product characteristic of the at least one member.

### BACKGROUND

The present invention, in some embodiments thereof, relates to presentation of search results and, more specifically, but not exclusively, to a presentation of search results in response to a search request presented by a user to a search service.

A search engine results page (SERP) is a web page that identifies search results that are returned by a search engine in response to a search query. Each search result may, for example, include a link to a resource, a title, an image, a text snippet that may identify where query terms occur within the resource, or other information.

Shopping search engines accept descriptions of a desired product or service that a user wishes to purchase, and return indications of webpages wherein the product or service is sold. The user may then purchase the product or service from a dealer indicated in the returned webpages. Common shopping search engines are price comparison search engines which return indications of webpages of dealers together with associated prices and/or technical details of the searched product.

### SUMMARY

According to some embodiments of the present invention, there is provide a system for updating an interactive product navigation user interface, the system comprising: a first interface for communicating with a client terminal used by a human user, a program store storing a code, and a processor coupled to the first interface and the program store for implementing the stored code, the code comprising: code to perform a plurality of interface updating iterations, during each one of the plurality of interface updating iterations, send instructions, via the first interface, to an application running on the client terminal to present an interactive product navigation user interface with an interactive indication, receive a user selection of the interactive indication from the application, select one of a plurality of products as a currently selected product according to the user selection, receive at least one reference product characteristic from a plurality of product characteristics of the currently selected product, and update the interactive product navigation user interface with at least one new interactive indication of at least one recommended product selected from the plurality of products, the at least one recommended product is selected according to a similarity between a characteristic value of the at least one reference product characteristic of the currently selected product and a respective characteristic value of the at least one reference product characteristic of the at least one recommended product.

Optionally, the processor is adapted for implementing a code for deducing the at least one reference product characteristic from a search query submitted by the human user.

Optionally, the processor is adapted for implementing a code for deducing the currently selected product from a search query submitted by the human user.

More optionally, the system further comprises a similarity dataset storing a plurality of characteristic values of the plurality of product characteristics of each of the plurality of products; wherein the processor is coupled to the similarity dataset; wherein the currently selected product is selected from an analysis of the similarity dataset.

More optionally, each one of the plurality of product characteristics having a marking as being a positive characteristic, a negative characteristic, or a neutral characteristic in the similarity dataset, wherein the at least one recommended product is selected according to the marking.

More optionally, the marking is deduced from sentiment analysis of a plurality of documents describing the plurality of product characteristics.

More optionally, the processor is adapted for implementing a mapping code comprising code to generate the similarity dataset by crawling in a plurality of web documents describing the plurality of products.

Optionally, the at least one recommended product is selected such that a plurality of characteristic values of a plurality of other product characteristics of the currently selected product and a respective plurality of characteristic values of the plurality of other product characteristics of the at least one recommended product are about the same.

More optionally, each one of the plurality of other product characteristics is associated with one of a plurality of weights used for selecting the at least one recommended product.

More optionally, at least some of the plurality of weights are determined according to a user characteristic of the human user.

More optionally, at least some of the plurality of weights are determined according to a prevalence of a respective characteristic value of the plurality of characteristic values among the plurality of products.

More optionally, the at least one recommended product is selected according to a ratio between an increment a value of the at least one reference product characteristic and a change to a plurality of characteristic values of the plurality of other product characteristics.

More optionally, each one of the plurality of other product characteristics is associated with one of a plurality of categories used for selecting the at least one recommended product.

Optionally, the interactive product navigation user interface comprises a plurality interactive indications including the interactive indication; wherein each one of the plurality interactive indications is associated with one of a plurality of reference product characteristics including the reference product characteristic; each one of the plurality interactive indications comprises a visual indication of one of the plurality of reference product characteristics.

Optionally, the at least one reference product characteristic comprises a plurality of reference product characteristics, at least some selected according to a type of the currently selected product.

Optionally, the at least one recommended product is selected so as to increase a variance coefficient among recommended products from the plurality of products which are associated with said plurality interactive indications.

Optionally, the at least one reference product characteristic is a user impression characteristic identified automatically by textual analysis of user uploaded content.

Optionally, the at least one reference product characteristic is a technical characteristic identified automatically by textual analysis of a plurality of product specifications.

Optionally, the at least one reference product characteristic is a User Usage characteristic identified by text analysis of a plurality of webpages.

Optionally, the at least one new interactive indication comprises at least one thumbnail of the at least one recommended product.

According to some embodiments of the present invention, there is provided a method for updating an interactive product navigation user interface. The method comprises performing a plurality of interface updating iterations, during each one of the plurality of iterations: send instructions to an application running on a client terminal to present an interactive product navigation user interface with an interactive indication, receive a user selection of the interactive indication from the application, select one of a plurality of products as a currently selected product according to the user selection, receive at least one reference product characteristic from a plurality of product characteristics of the currently selected product, and update the interactive product navigation user interface with at least one new interactive indication of at least one member of at least one recommended product selected from the plurality of products, the at least one member is selected according to a similarity between a characteristic value of the reference product characteristic of the currently selected product and a respective characteristic value of the reference product characteristic of the at least one member.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a product discovery method of generating presentation that includes interactive product indications automatically calculated and generated based on a similarity to one or more reference product characteristics of a selected product, according to some embodiments of the present invention;

FIG. 2 is a schematic illustration of a network node for generating a presentation, for example by implementing the process depicted in FIG. 1, according to some embodiments of the present invention;

FIG. 3 is a graph presenting percentiles, according to some embodiments of the present invention;

FIGS. 4A and 4B are schematic illustrations of exemplary GUIs wherein the interactive product navigation indications are indicative of the reference product characteristics, according to some embodiments of the present invention; and

FIGS. 5, 6A-C, 7A-B, 8, 9, 10, 11, 12 and 13A-B are schematic illustrations of an interactive discovery UI GUI, according to some embodiments of the present invention.

### DETAILED DESCRIPTION

The present invention, in some embodiments thereof, relates to presentation of search results and recommendations and, more specifically, but not exclusively, to a presentation of search results in response to a search request presented by a user to a search service or a presentation of purchase recommendations.

According to some embodiments of the present invention, there are provided methods and systems for generating and updating a product discovery user interface (including any product recommendation tool) based on similarity measures. The product discovery user interface allows user to navigate between different products which are recommended for them with a single action such as a single click, gesture or touch. The navigation is iteratively performed from a currently selected product to one or more other product(s) that has a more positive or less negative reference product characteristic and other product characteristics which are about the same (e.g. in a predefined range). The other products are optionally selected using a similarity dataset that records values of product characteristics of each product in a plurality of categories. The similarity dataset is optionally updated, for instance continuously or iteratively based on analysis of web available sources, such as web pages, document specifications, social media content and/or any other web content that contributes to the understanding and knowledge of products such as reviews, news, and the like. The similarity dataset optionally set, for each product characteristic, a positive/negative/neutral/unknown value. The similarity dataset optionally set, for each product characteristic, a weight, optionally dynamic, that reflects the importance of the product characteristic to users who are interested to purchase the product or other products at the product category. The similarity dataset optionally documents product characteristics such as technical features, user impression values, user usage indications and/or the like.

The product discovery user interface is optionally automatically generated to reflect similarity between recommended products and a currently select product. The similarity may be reflected by edges of a graph indicating a difference in values of a reference product characteristic of products marked by nodes. The similarity may be reflected by an order of products in an array. The similarity may be reflected by any other variability of a visual element used to indicate a product.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

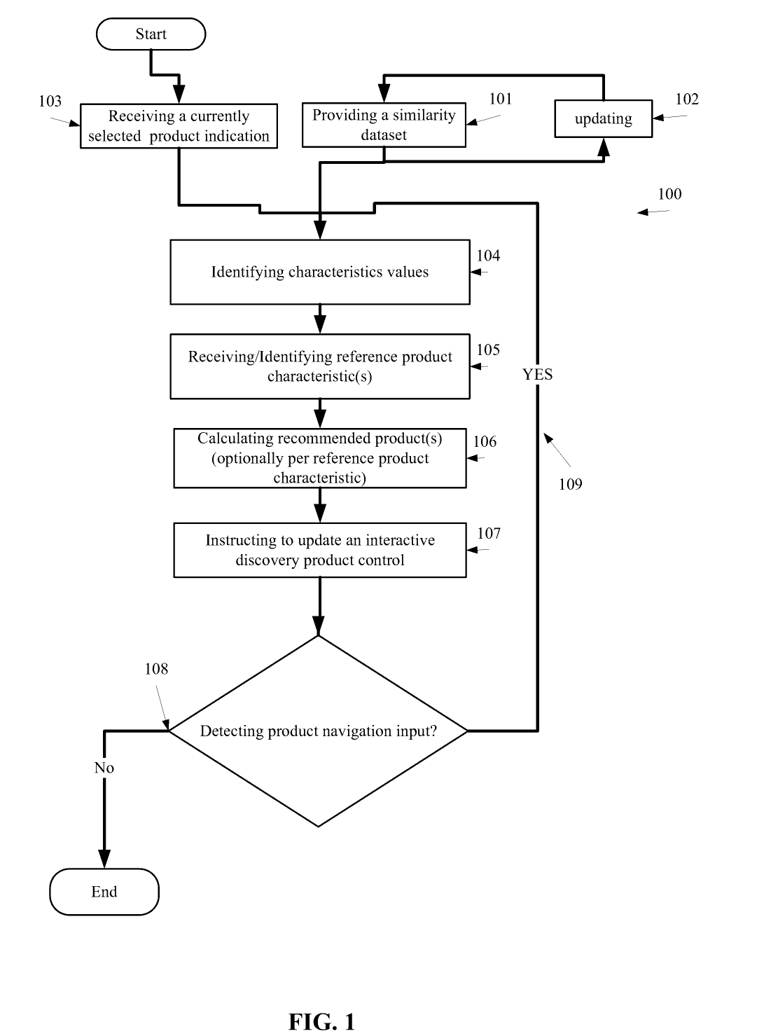

Reference is now made to FIG. 1, which is a product discovery method 100 of generating an interactive control that allows a user to navigate between different products where interactive product indications of the interactive control are updated after each user selection based on a similarity dataset mapping similarity between products, according to some embodiments of the present invention. First a product is selected, optionally by the user, for instance a product identified by the user as relevant product to purchase. The product may be deduced from product indications, such as query words and/or images and/or manually selected from a landing page of a search engine. The product may also be deduced from an analysis of content of a webpage, for instance by a webpage add-on and/or a webpage script such as a software development kit (SDK) module. For example, the product discovery method receives as an input a product indication and optionally one or more reference product characteristics and generates an interactive discovery product user interface (UI) that simplifies the process of reviewing (also referred to as navigating) between alternative related products. The input may be a query, such as a query that includes a product brand or model and deduced reference product characteristics and/or a query that includes desired reference product characteristics and a deduced product brand or model. The input may be a selection of a product indication, for example an image, a thumbnail or a link.

As used herein, a product may be any real or virtual product or service offered for sale and/or otherwise available for purchase via a web document, such as a webpage.

The interactive product indication is a selectable visual element, such as a GUI element that includes a description of a product and optionally one or more of its product characteristics, for example an image or an icon of a product and optionally text segments and/or icons. As used herein, an interactive product indication may be a user selectable icon, a user selectable image, an icon, a product thumbnail, a user selectable textbox, a user selectable mosaic, a user selectable video clip, a user selectable graphics interchange format (GIF) file, or any other interactive product indication which may be rendered on a display to allow a user to select an imaged product. The interactive product indications may be product suggestions selected according to an analysis of product characteristics in various dimensions, such as a product usability dimension mapped by analyzing product reviews from webpages, blogs, and/or social media, a product specification dimension mapped by analyzing product specification from one or more product webpages and/or product dealer webpages, and/or any other dimension.

As shown by 102, the product discovery method 100 may be an iterative process wherein a user reselects products and/or reference product characteristics, optionally by single click or touch, for navigating sequentially between different interactive product indications until a desired outcome is presented thereto. When used in the retail space, for example as described below, the interactive product indications may be presented as recommendations and/or suggestions given in relation to the selected product, optionally with a purchase button to allow a user to proceed with the purchase. Such recommendations and/or suggestions are not given solely based on behavioral data about what other users purchased, for instance solely based decisions of users with similar usage patterns, for instance solely based on what similar users have bought and/or which products are frequently bought together with a selected product. The recommendations and/or suggestions are given by the interactive product indications are recommendations and/or suggestions set according to a similarly of product characteristics, for example as described below.

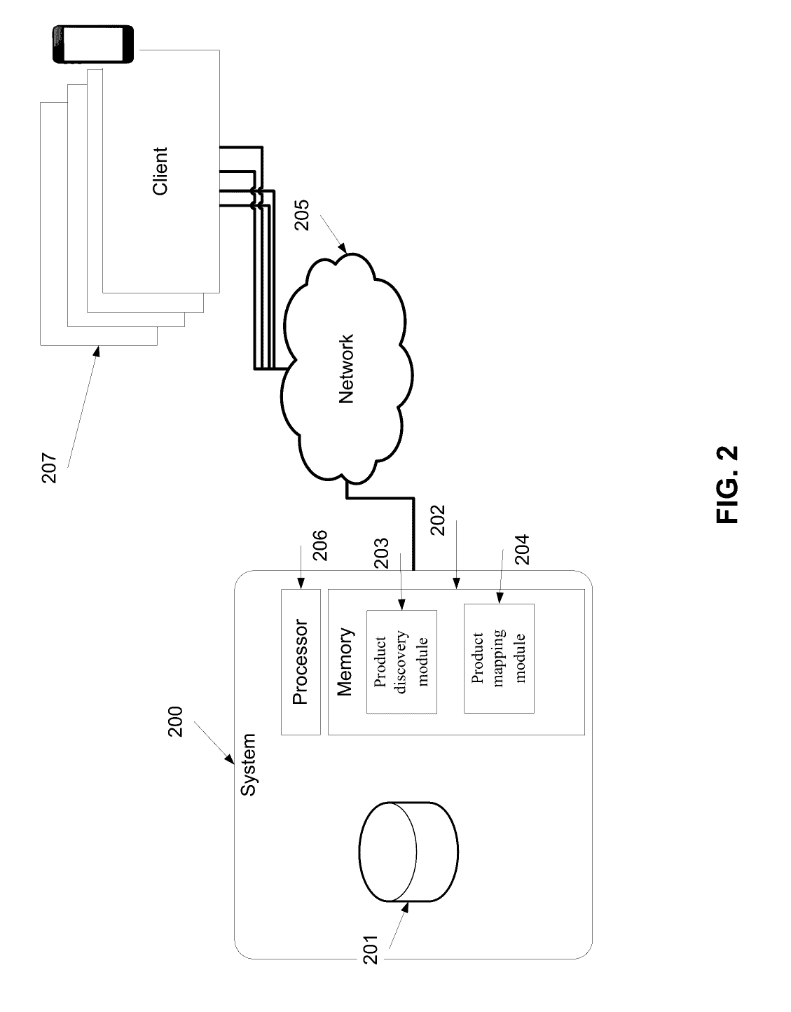

Reference is now also made to FIG. 2, which is a schematic illustration of a system 200 for generating a presentation of an interactive discovery UI, for example by implementation of the process depicted in FIG. 1, according to some embodiments of the present invention. Optionally, the system 200 is a network node, such as one or more servers having a similarity dataset 201 mapping values of product characteristics of each of a plurality of products, and a memory 202 for hosting a product discovery module 203 and a product mapping module 204. Modules 203, 204 are implementable on one or more processors 206 for generating the interactive discovery UI, for instance by responding to a query identifying a user selected product with a presentation that includes interactive product indications automatically calculated and generated based on similarity to the user selected product, for example as described in FIG. 1. FIG. 2 further depicts a computer network 205 such as the internet, and a plurality of clients 207 which allow users to interact with the presentation that includes interactive product indications.

The interactive discovery UI is optionally implemented as a GUI comprising interactive product indications, for instance an active web application display and/or any browser element adapted to be rendered by browser and/or an application element adapted to be rendered by a product discovery application and/or an application supporting a product discovery function. The interactive discovery UI is optionally presented on a display of a client device 207, for instance rendered by a browser or an application running on the client device 207. In some embodiments, a Software Development Kit (SDK) element is added to the code of existing websites so as to allow a user accessing one of the websites to interact with the interactive product indications without leaving the accessed website. The interactive discovery UI may be implemented to be presented to a user any device that supports product search and discovery, for instance set to be displayed by wearable devices and/or augmented reality devices such as Google Glass.

As shown at 101, the similarity dataset 201 maps or allow deducing similarity between products based on values of product characteristics. The similarity dataset 201 may be generated by running the product mapping module 204. For example, each product is documented in a product record that logs values of the respective product characteristics. Each of the product characteristics can be represented with a numeric representation (e.g. continuous or discrete), a Boolean representation, and/or multi-choice representation, such as a single value (e.g., the color of a cell phone) or a multi value (e.g. frequencies on which a cell phone operates), and/or by a UI element that allows a user to select a value or a range of values, such as a scale or slider for adjusting and locating specific values.

Similarity can be evaluated by comparing values as described below.

Characteristics values may be from one or more of the following groups of data:

Technical data (e.g. based on product specification);
User impression data (For example: product reviews, product ratings, “Best Value for Money”);
User Usage data (e.g., statistical analysis of how uses the product and/or when); and Objective Ranking (e.g. “Top Selling” or “highest rated”).

The above characteristic values may be extracted for some or all of the documented products from webpages available over the internet and contain data used for generating product records and/or analyzed to determine values such as importance, relevancy, trendiness, popularity, quality, compatibility, and commercial value and to set weights accordingly.

Reviewing all the product characteristics of all products (in a single category of products) and combining them creates the list of characteristics for a category (this is the list that can be seen in the left column of the table above).

According to some embodiments of the present invention, each of the product characteristic in each product category is weighted with one or more weights (e.g. score(s)) to indicate a current importance of the characteristic to a typical purchaser and/or a specific purchaser, for example as elaborated below.

Optionally, product characteristics are dynamically weighted according to a suitability of demographic sector indicator (e.g. age sector, gender, social economic sector, and/or a profession). Product characteristics may be weighted according to a suitability to other clusters and/or segments which are discovered through search and Browse behavior, for example a documented as a shopper behavior.

Such a weight may be referred to as a usability indicator. This allows indicating with a value a suitability of a device for kids, elderly sector, and/or the like. Additionally or alternatively, the demographic sector suitability may be a product characteristic.

Another indicator may be a general sentiment indicator about a functionality or a structural element of the product, and/or a perceived characteristic indicator indicating how the product is perceived by users or group of users. This may be done by monitoring a trend indicating changes in the number of new references (e.g. per day) to a product in web documents such as blogs and social media posts. As above, this indicator may be implemented as a dynamic characteristic weight and/or as a product characteristic.

Optionally, a product characteristic is weighted such that certain product characteristics are ranked higher than others for the respective product category. In such embodiments, each product characteristic that is held, assigned, estimated and/or calculated is associated with a weight, for example a level of importance for a buyer purchasing products from the respective category. For instance, when buying a Smartphone, a brand is associated with a weight 10/10, a screen size is associated with a weight 9/10, and a screen resolution is associated with a weight 7/10.

Optionally, weighting may be dynamically adapted according to user attributes such as internet protocol (IP) value, a demographic segment such as an origin Country, Age, and gender, a used access device, history analysis (e.g. offers clicked and/or ignored), and/or the like. Optionally, weighting may be dynamically adapted according to statistical analysis of user responsiveness.

Additionally or alternatively, a weight may be dynamic and adapted according to a sentiment indicator indicating how the product characteristic is perceived by users or group of users during a period. This may be done by monitoring a trend indicating changes in the number of new references (e.g. per day) to a product characteristic in web documents such as blogs and social media posts. For example, when articles about screen resolutions of Smartphones are growing, the weight of the product characteristic screen resolution in the category “Smartphones” is updated. In another example, weights are dynamically updated according to search words used for searching for products in the respective product category and/or for a specific product, for instance search words in the query submitted in 102. The search words may be monitored when the product discovery method 100 is executed by different users and/or acquired from other search engines.

Optionally, weighting is personalized according to parameter of a user submitting a query, for instance by inputs indicative of importance of product characteristics as described below. Optionally weighting is personalized according to the user's individual usage patterns and preferences.

In an exemplary dataset, a product records is generated as follows:

| | | |
|---|---|---|
| Product characteristic 1 | Weight 1 | Positiveness |
| | | (Positive/Negative/Natural) |
| Product characteristic 2 | Weight 2 | Direction |
| . . . | . . . | . . . |

According to some embodiments of the present invention, each of the product characteristic in each product category is marked with a positiveness value and/or function (for brevity referred to herein as a positiveness value) to indicate whether a given characteristic value is a positive indication and/or a negative indication and/or a neutral indication and/or an unknown indication. The positiveness value may be recorded by associating an indication (e.g. an entry) representing whether the value respective product characteristic is positive to a potential purchaser, negative to a potential purchaser, unknown, or natural. For example, the positiveness value is determined based on a textual analysis of reviews. For example, a textual analysis may indicate that a vast majority of customers prefer having a waterproof screen to a product in the category Smartphone and hence the product characteristic waterproof screen is associated with a positive indication. In another example, from textual analysis of reviews indicates that a vast majority of customers prefer having a lighter Smartphone and hence the weight product characteristic is associated with a negative indication.

A product characteristic may be neutral when a vast majority of the potential customers do not care about the respective product characteristic. In an exemplary product category, positive entry is given to product characteristics such as a Memory size, Central processing unit (CPU) power, a negative entry is given to product characteristics such as Mean time between failures (MTBF), Width, Weight, and price and a natural entry is given to product characteristics such as a number of Seats in a car or screen size in a laptop. This means that there is no clear desired direction for this value, but it is a matter of preference or personal taste for a single potential buyer.

Optionally, a positive indication and/or a negative indication and/or a neutral indication and/or an unknown indication is manually set by the operator and/or automatically set by sentiment analysis of web documents and/or queries in sources to detect attributes of potential purchasers to the product characteristic. The web documents include product specs, product reviews, and/or Blog webpages. The queries may include search queries on General Search Engines such as Google, Bing, etc. and on retail search engines such as Amazon and Best buy. Additionally, social search engines such as Facebook and Twitter may serve as sources for such sentiment analysis.

Optionally, the positiveness value is a function, for instance a function representing a histogram of values changed based on one or more input values. In such embodiments, the positiveness value may be changed as a derivative of values one or more other product characteristics. The change may be linear or a non linear. Such a function may represent a non linear correlation between a characteristic and a positiveness value, for instance reflects a situation when buyers of mobile devices prefer big screens when the screen size is up to ˜5.5 inch, but are neutral about screens bigger than 5.5 inch. Optionally, a certain value may be positive while lower and higher values are neutral or negative, for instance the value 5.5 inch.

It should be noted that the indication may change over time. For example, the above sentiment analysis may indicate that the sentiment about a screen size is changing from positive to neutral in the product category laptops as the consumers changes their preference for larger screens.

Optionally, the running of the product mapping module 204 executes one or more web crawlers which update the similarity dataset 201 by extracting characteristic values of product characteristics from an analysis of the web documents such as articles, reviews, social media posts and/or the like.

For example, for the exemplary product category ‘Smartphones’, a general table may be assigned with values as follows:

| | | Product |
|---|---|---|
| Product characteristic name | Product characteristic Weight | value |
| Screen size | 9 | Positive |
| CPU speed | 8 | Positive |
| Memory | 8 | Positive |
| Waterproof | 5 | Positive |
| Price | 10 | Positive |
| Review score | 9 | Positive |
| Weight | 4 | Negative |

This allows automatically generating product records using the general table. For Example, For the product ‘Samsung Galaxy s5’ in the category ‘Smartphones’, an exemplary table (e.g. dataset) may be as follows:

| Product | Product | | |
|---|---|---|---|
| characteristic | characteristic | Product characteristic | |
| name | Weight | Direction | Product value |
| Screen size | 9 | Negative | 6 |
| CPU speed | 8 | Positive | 2.4 GHz |
| Memory | 8 | Positive | 32 GB |
| Waterproof | 5 | Positive | No |
| Price | 10 | Positive | $460 |
| Review score | 9 | Positive | 4.3 Stars |
| Weight | 4 | Negative | 129 gram |

Optionally, as shown at 102, the product records in the similarity dataset 201 are updated based on continuous or iterative crawling of sources. Such updating may include detection of new product categories, for by a detection of a reference to an uncategorized product in a monitored webpage, a detection of a new or an obsolete product, an updating of weights and/or product characteristics, for example by adding or removing product characteristics, and/or a detection of an obsolete product category or product.

As shown at 103, a product indication is received, for example via an interface 207, by an analysis of one or more search words in a product search query provided by a user to a search engine landing page and/or input text field, and/or application. The product search query may be inputted by any man machine interface, for example recorded in an audible manner and/or selected from a video and/or image gallery and/or deduced from a behavioral pattern of a user.

As shown at 104, the product record of the product pointed by the product indication is identified in the similarity dataset 201 such that characteristic values of product characteristics and the respective product category are identified.

Optionally, as shown at 105, indication(s) of one or more reference product characteristics, for instance user selected product characteristic(s) and/or predefined reference product characteristics, are identified. A user selected product characteristic(s) are optionally selected by a user interface so as to allow a user to reflect a desire for a product having these product characteristic(s) with “better” value while maintaining or mostly maintaining the value(s) of other product characteristic(s). A predefined reference product characteristic may be a reference product characteristic defined by a designer of the GUI of the interactive discovery UI.

This allows, as shown at 106, identifying one or more products from the product category, for instance by executing the product discovery module 203. Optionally each of the one or more products is identified for one reference product characteristic or for any combination of reference product characteristics. Each product is selected according to value proximity (or similarity). The value proximity is determined by matching between one or more characteristic values of the reference product characteristic(s) of the selected product and respective characteristics values of products from the product category in the similarity dataset 201. The one or more characteristic values are optionally of user selected product characteristics and/or product characteristics identified as suitable to the user from which of for which the product indication was received.

It should be noted that similarity of a product characteristic may be determined based on the range of values of the values of these product characteristic in the similarity dataset and/or in a training set. The range allows determining relative values (e.g. solving the issue of what is light, what is heavy, what is small etc.).

The ranges may be deduced an analysis of values of product characteristics and/or their weights (or importance) and/or from an analysis of web browsing behavior and shopper behavior and/or search behavior, as well as from trends of product characteristics, such as the number of new devices (e.g. Smartphones) that have a certain value (e.g. weight).

As indicated above, a similarity to a number of reference product characteristics is estimated, regardless of the origin of the reference product characteristics (e.g. can be predefined and/or user selected). For example, laptop1 is estimated to be similar to laptop2 in all parameters while laptop2 has a more positive value (higher expert rating) and a less positive value (e.g. higher price). When multiple products are available, laptop_a, laptop_b, laptop_c may be similar to laptop1 while it differs from laptop_a by product characteristics x, y, z and from laptop_b by product characteristics u, v, w etc (i.e., product characteristics x, y, z might not be the same as product characteristics u, v, w). Selected product characteristics for a product, for example the price, may have a different similarity requirement. Optionally, the selected product characteristics are adapted to the product type such that product characteristics selected for one product type are different from the product characteristics selected for another product type. The selection of the product characteristics is optionally done automatically according to an analysis of weights or similar factors.

Reference is now made to an exemplary process of identifying one or more recommended products from a set of products of a certain reference product characteristic, for example from the recommended products 201. Optionally, all the values in the product records are normalized. This process is repeated for each reference product characteristic. For brevity:

A denotes a currently selected product X from category C;

B denotes a product from category C, for instance a replacement product from category to offered in response to the selection of A;

C denotes a category of A and B;

P denotes a reference product characteristic;

M denotes a weight of P in category C;

D denotes positiveness of P (e.g. positive, negative, Natural, and/or unknown);

and

P(a) denotes a prevalence of a value of reference product characteristic P for product A. The prevalence is optionally a percentile. For example when a is screen size and P(a)=80% a product A having a screen size in the 80^{th} percentile of screen sizes in the respective category, for instance smartphone;

Pnot-p (A) denotes a prevalence of product characteristic P for a product characteristic that is not A. The prevalence is optionally a percentile.

α (alpha) denotes a Constant representing a non-linearity of a weight of a Product characteristic;

I denotes a weight of P; and

N denotes a number of alternative products.

The process may be defined as follows:

Process 1:

Define for each P M=M*D

For each Product characteristic

For each possible B
If abs(M)>=4
Benefit=exp(alpha*I)*(P(b)−P(a))
Cost=−Sum(exp(alpha*I)*min(0,(Pnot-P(b)−Pnot-p(a))))
Difference(A, B, P)=Benefit−Cost

where 4 denotes a normalized percentile benefit for choosing product B instead of A and the Cost is the cost for all other product characteristics of product B where only negative values are taken. When there is a benefit that is not the main benefit outcome is ignored. Process 1(cont.):

For index from 1 to N

Chose max(Difference(A, B, P)) on all B and all P
Assign Product B as a replacement for A
Ignore B and A on the next loop

Results:

For product A, the alternative products are

Vector of N products (B₁, . . . ,Bₙ)

With properties (product characteristics)

Vector of N properties (P₁, . . . ,Pₙ)

Respectively

Process 1 allows generating a recommendation for replacing a currently selected product with a new product based on a difference in a reference characteristic where the values of the other product characteristics of the new product are similar or identical to the values of the product characteristics of the currently selected product. In such a manner, a recommendation for replacing a currently selected product is determined according to a tradeoff ratio between an increment a value of the reference product characteristic and a change to the other characteristic values of the product characteristics in the recommended product. The reference product characteristic is optionally selected by the user, selected based on the user profile, preferences or queries and/or according to a matching analysis.

When P denotes a Boolean value, a fixed percentile (for example: 100 and 0) is assigned. The percentiles assigned for “true” and “false” on Boolean product characteristics may vary between product characteristics. When a product characteristic is location specific, for example having a power adaptor of 220 volt (V) or 110V, it should be excluded from the calculation.

Optionally, α is derived from user click statistics. Optionally, multi value product characteristic are represented by an array of values, optionally Boolean, wherein each value represents one component, for example, a phone frequency is a component of frequencies supported by a product.

According to some embodiments of the present invention, product characteristics are categorized. This allows selecting a combination of product characteristics for increasing the variance among recommended products. For instance, categories may be technical characteristics, such as specification extracted data (e.g. resolution of a sensor of a camera), General characteristics, such as sentiment characteristics extracted from analysis of social media data as all the product characteristics that are general in nature, since they appear in all categories over all products (Popularity, Trendy, Quality), and usage characteristics, such as indicating with a value a suitability of a device for a demographic segment or usage type.

The combination allows configuring the selection to comprise a mix having a predefined ratio of between the categories of the recommended products. For example when N=10 a ratio of 2-4-4 is desired where 2 products have similar technical characteristics, 4 have similar General characteristics, and 4 have similar usage characteristics. Such recommended products may be presented in association with the currently selected product.

Optionally, a prevalence of a value of a product characteristic is calculated as an average percentile of the value in the product characteristic of products from this category. For example, when the product characteristic is a screen resolution having three optionally values: 0.5K, 1K and 4K and 600 products are assumed to have 0.5K resolution, 399 products have 1K resolution, and only 1 product has 4K resolution, the prevalence (e.g. percentile) is calculated as follows:

| Screen Resolution | Products | Calculated prevalence (e.g. Percentile) |
|---|---|---|
| 0.5K | 600 | (600/2)/1000 = 30% |
| 1K | 399 | (600 + (399/2))/1000 = 79.95% |
| 4K | 1 | (600 + 399 + (1/2))/1000 = 99.95% |

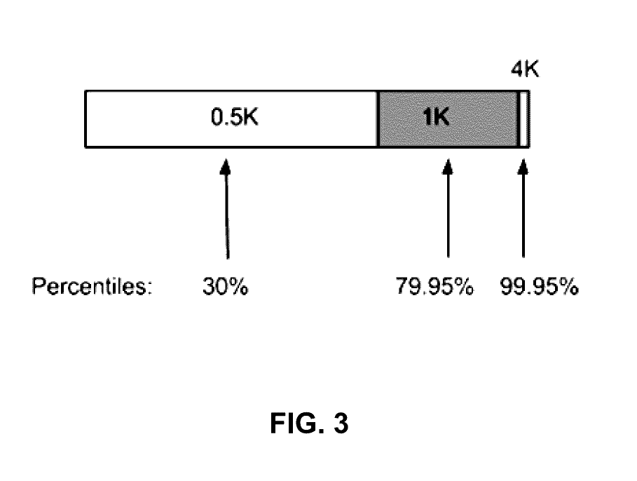

See also the graph in FIG. 3 where arrows denote locations of the percentiles. Note that they are not at the ends of the sections but at the middle.

Now, as shown at 107, instructions to update a GUI for navigating among recommended products are calculated. For example, interactive product navigation indication(s) each allowing a selection of product is calculated. Each interactive product navigation indication is optionally an indication of recommended products, for instance a thumbnail, an icon, or a text describing one or more of the recommended products. If a number of members are presented, the interactive product navigation indication allows selecting any of the presented members. For example the GUI may include a number of images of products, each selected for another reference product characteristic (e.g. JPEG, GIF, icon, and/or any other visual representation).

As shown at 108, this allows a user to navigate from one product to another by a single click, a single finger tap or a single gesture. During this navigation, the navigating user hops from a currently selected product to another product having the respective reference product characteristic with a more positive (or less negative) value while values of other product characteristics in the navigated to product remain substantially the same (e.g. about 10% difference or any other similarity threshold). The navigation is facilitated, as shown at 109, by iteratively assigning a product indicated by a user selected recommendation as a currently selected product and repeating 104-107 with the newly assigned product and optionally with reference product characteristics.

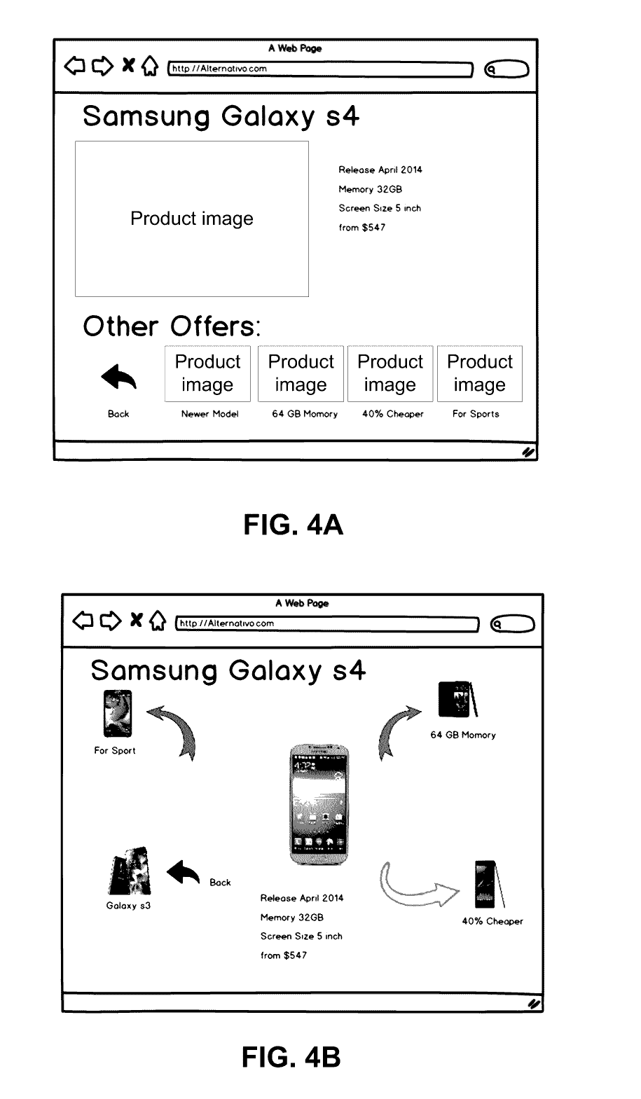

Reference is now made to exemplary GUI which may be presented to allow a user to navigate between different products based on similarity of reference product characteristics. For example, FIGS. 4A and 4B are exemplary GUIs wherein a selected product 300 is presented as an image and descriptive text with 4 exemplary product characteristics (a release date, a memory size, a screen size, and a price). Four product navigation indications, such as 302, are presented to the user as thumbnails which image products. Each product is selected based on another reference product characteristic (release date, memory size, screen size, and price). In such a manner, the user is presented with a single display or control that allows him to navigate between products based on a single product characteristic which is most important to him.

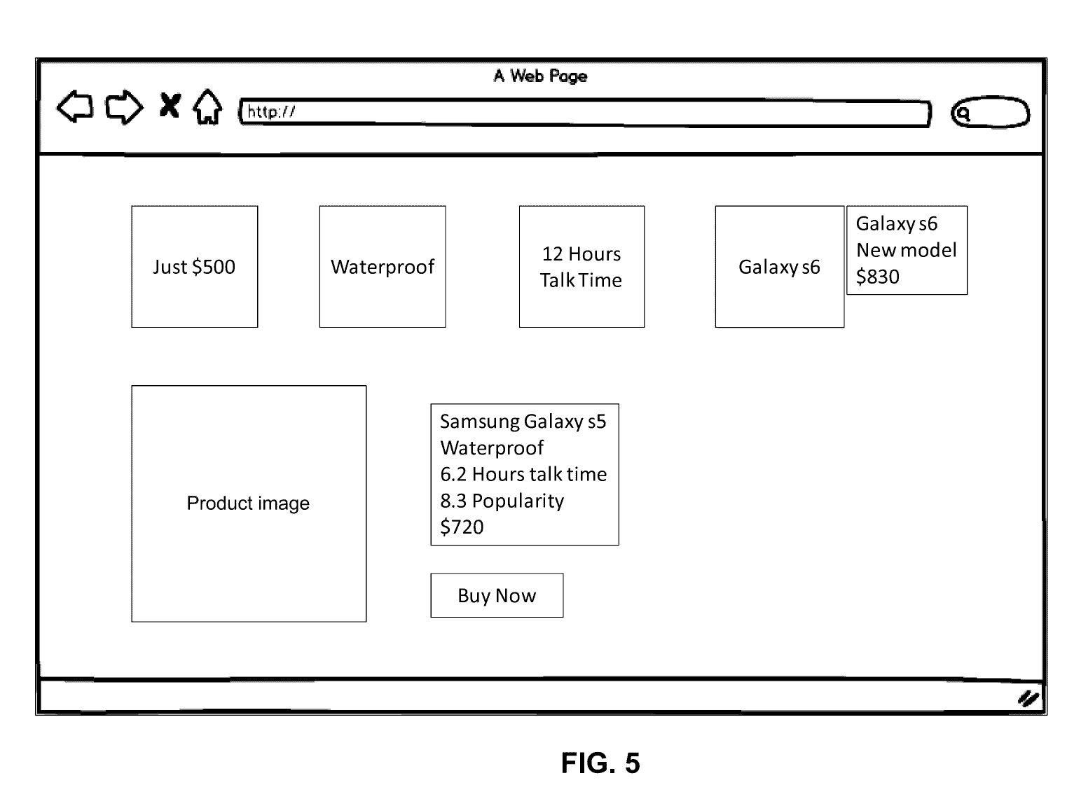

Another example is presented in FIG. 5 which is a schematic illustration of an exemplary interactive discovery UI wherein the interactive product navigation indications are indicative of the reference product characteristics only. Optionally, a product is revealed in response to a user selection of one of the reference product characteristics. For example, FIG. 5 is a schematic illustration of exemplary interactive discovery UI having flip card buttons are presented, allowing a user to reveal a suitable product after selecting a reference product characteristic. This provides a layer of gaming to the navigation. Each revealed product may be selected as a currently selected product to allow repeating 104-107.

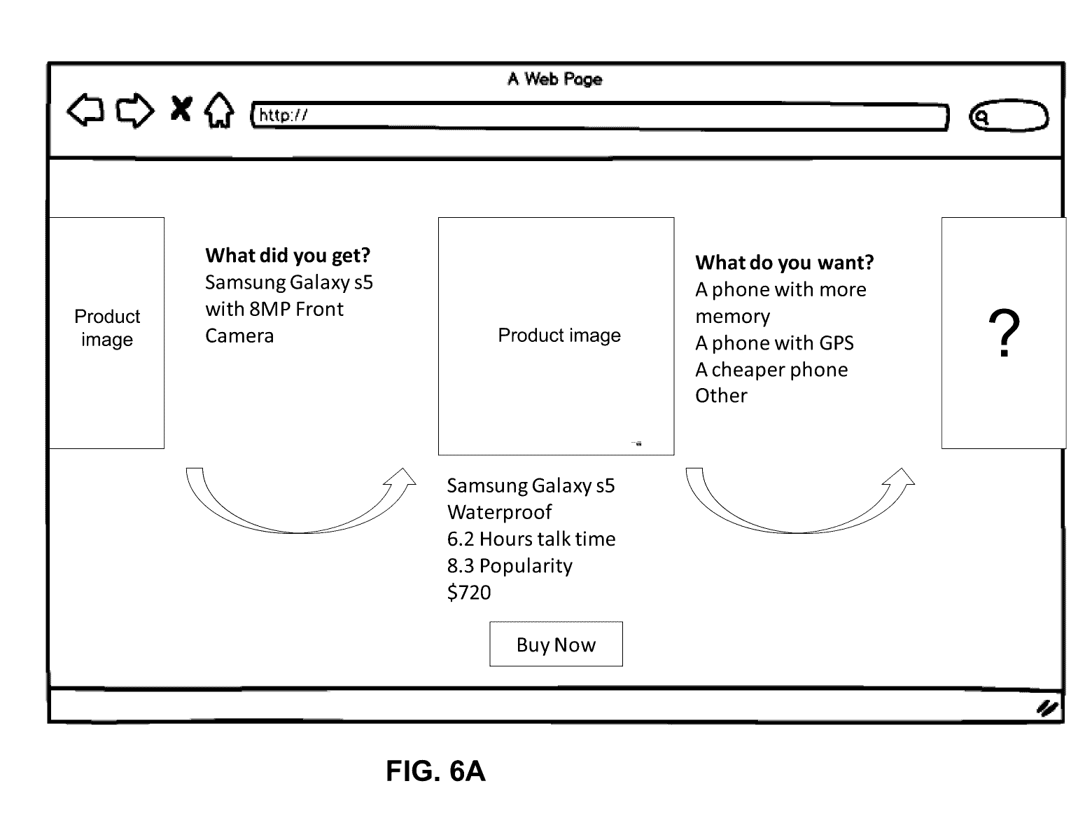

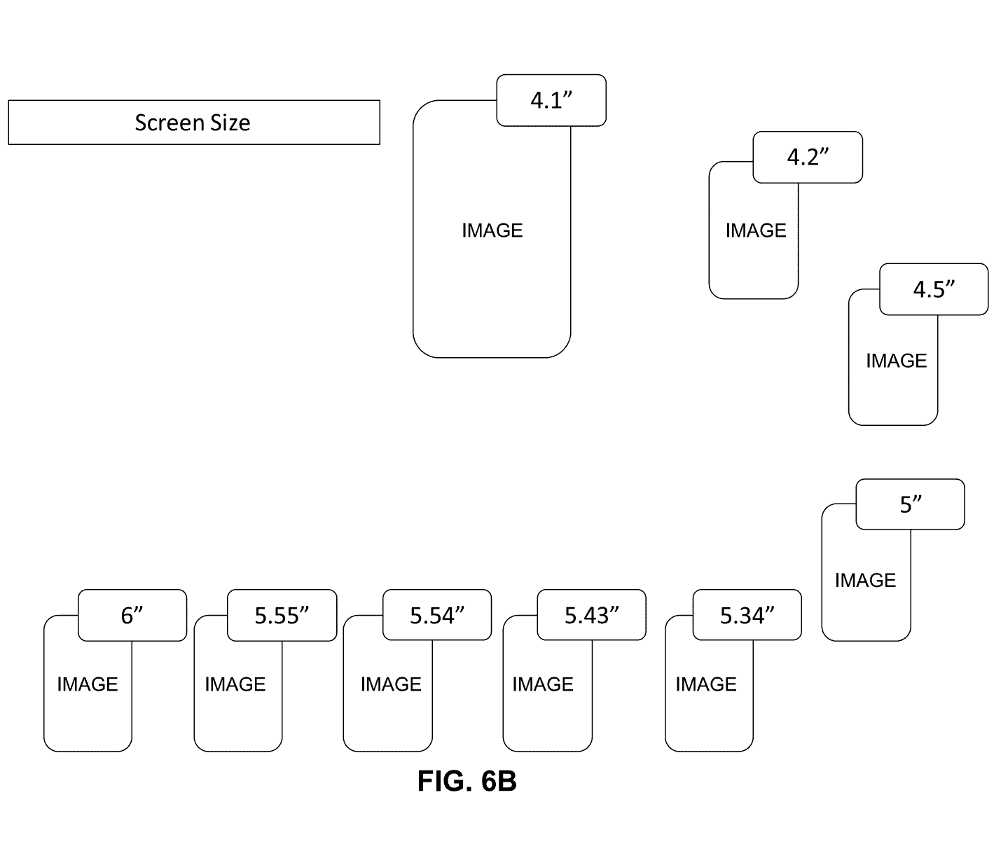

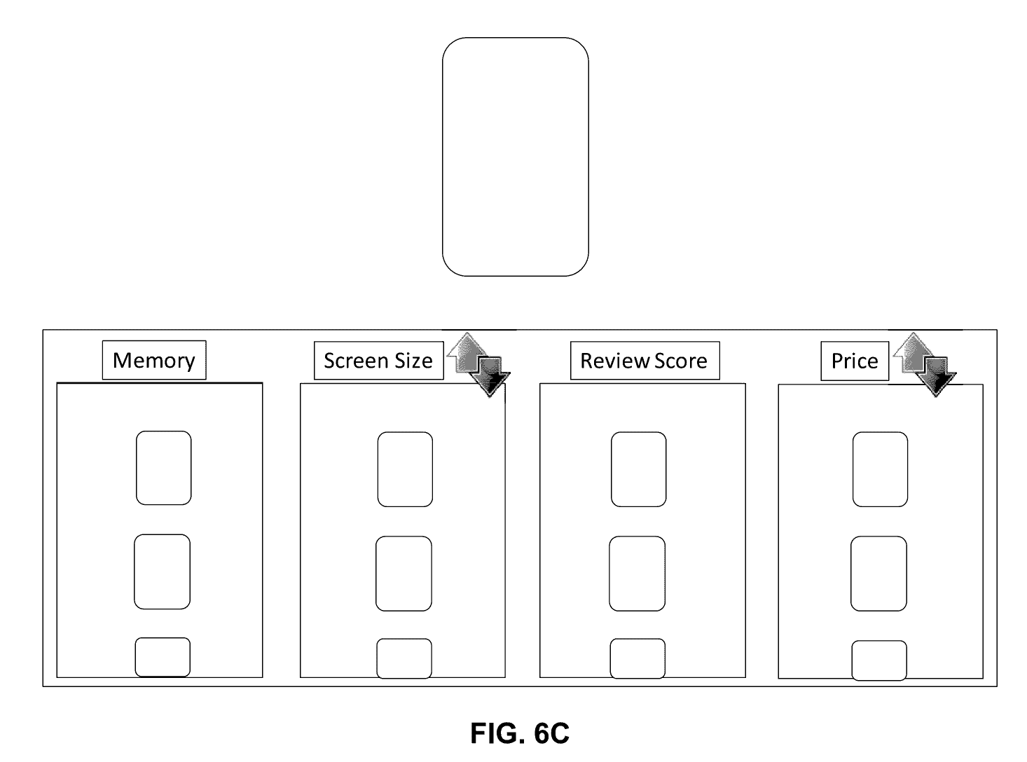

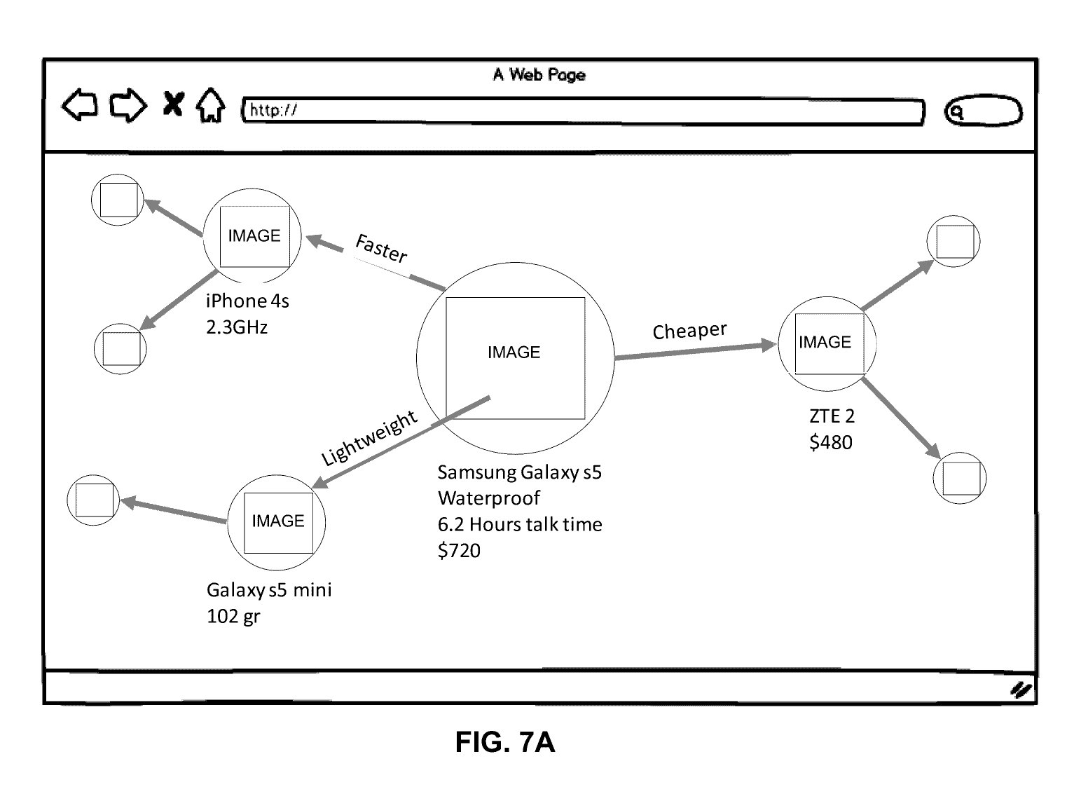

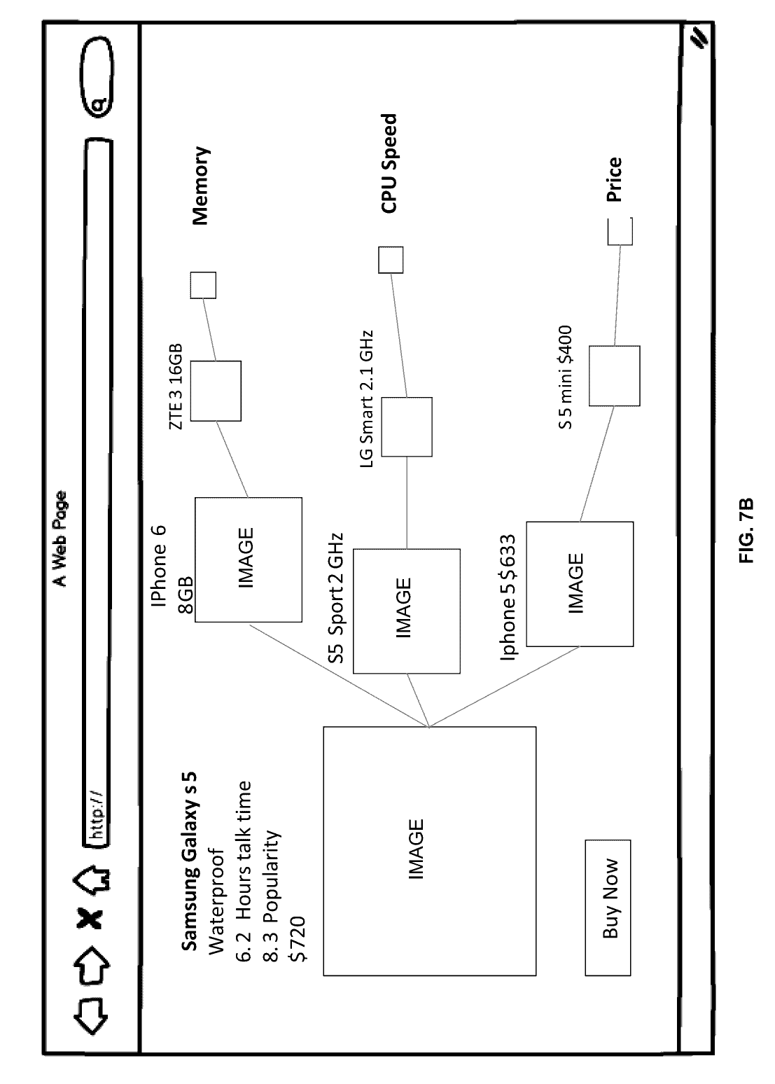

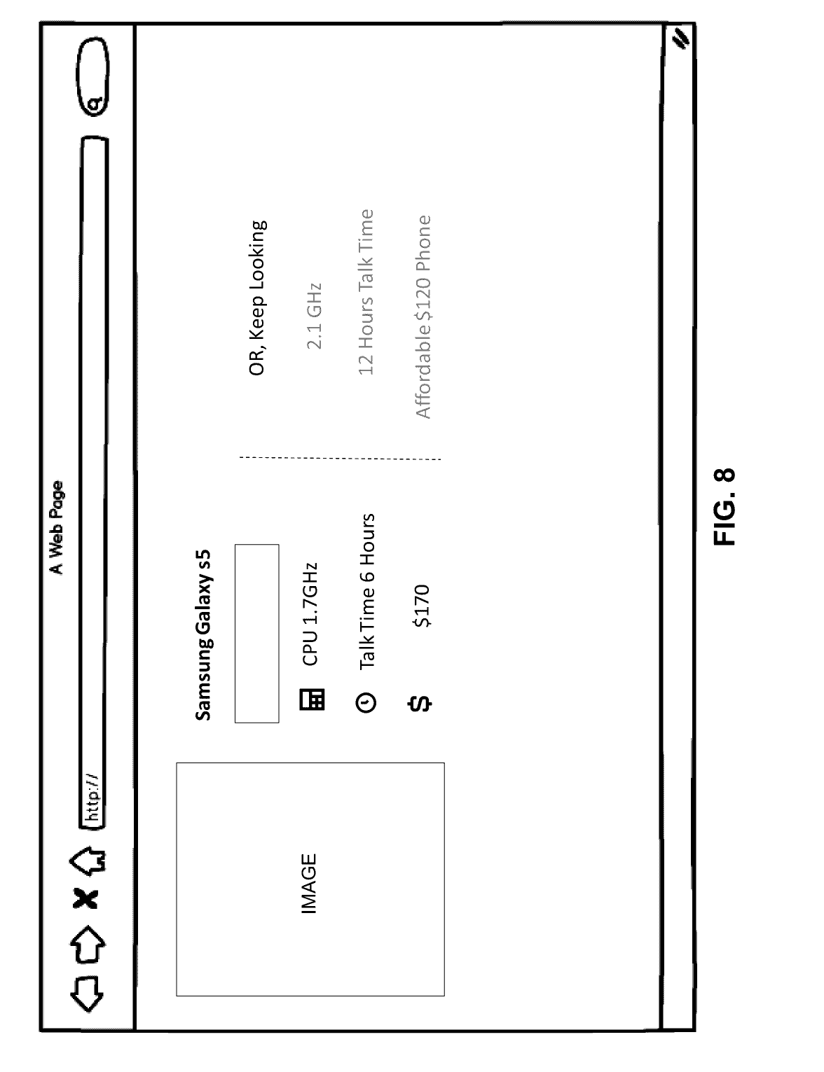

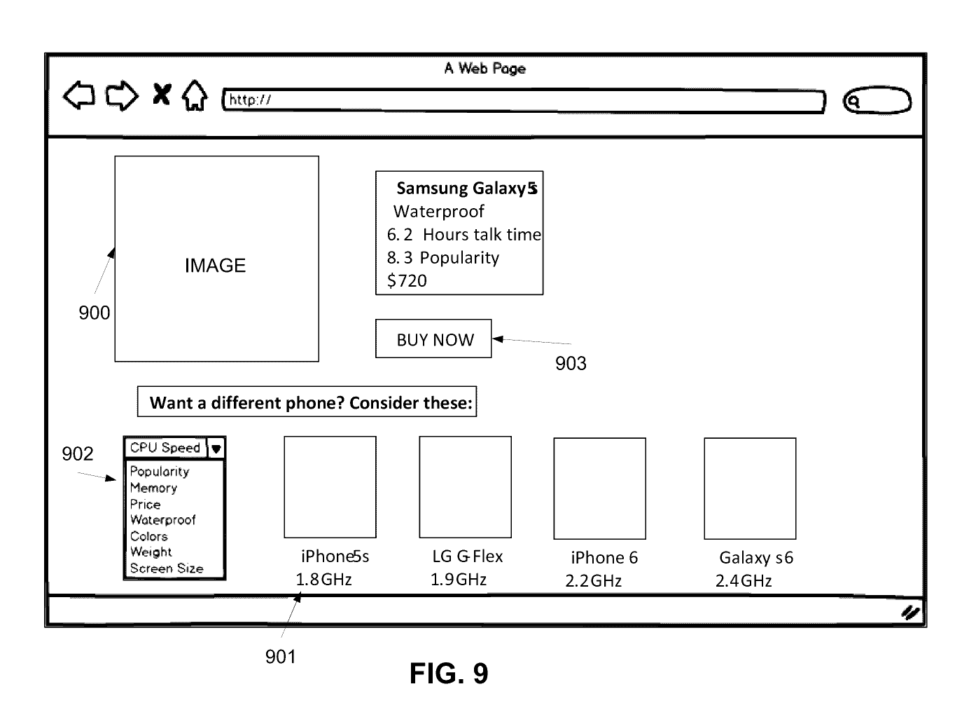

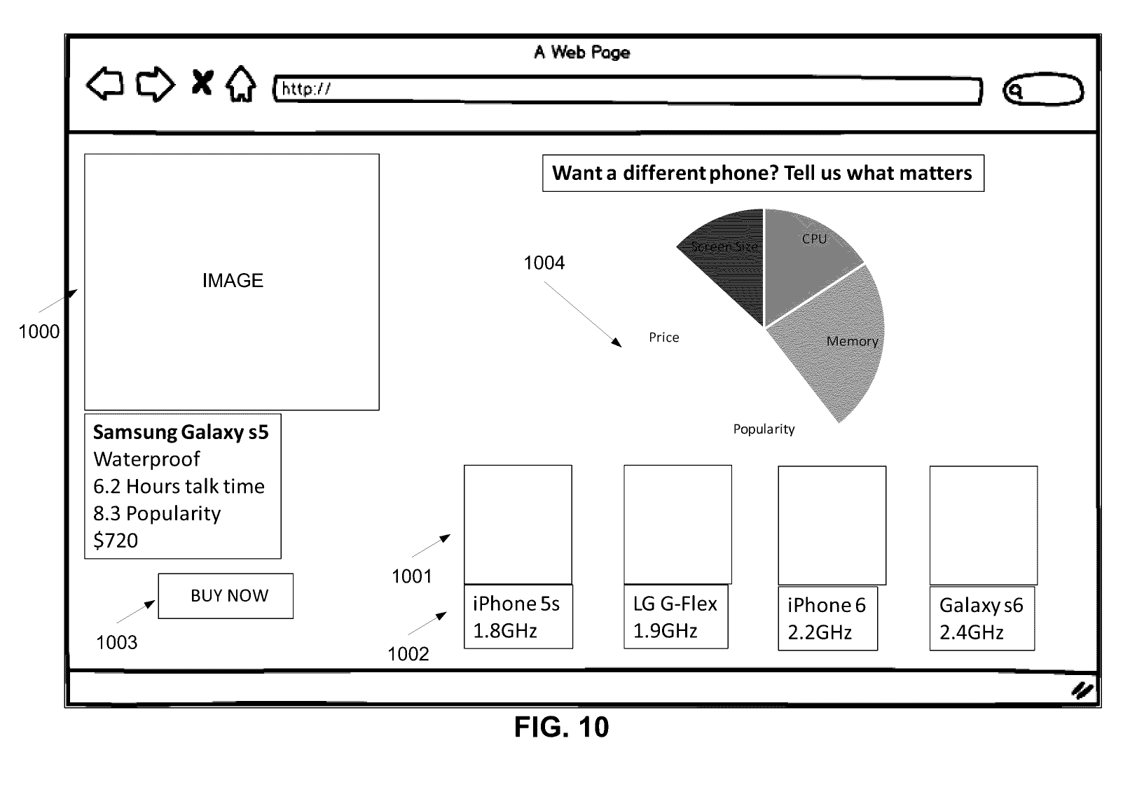

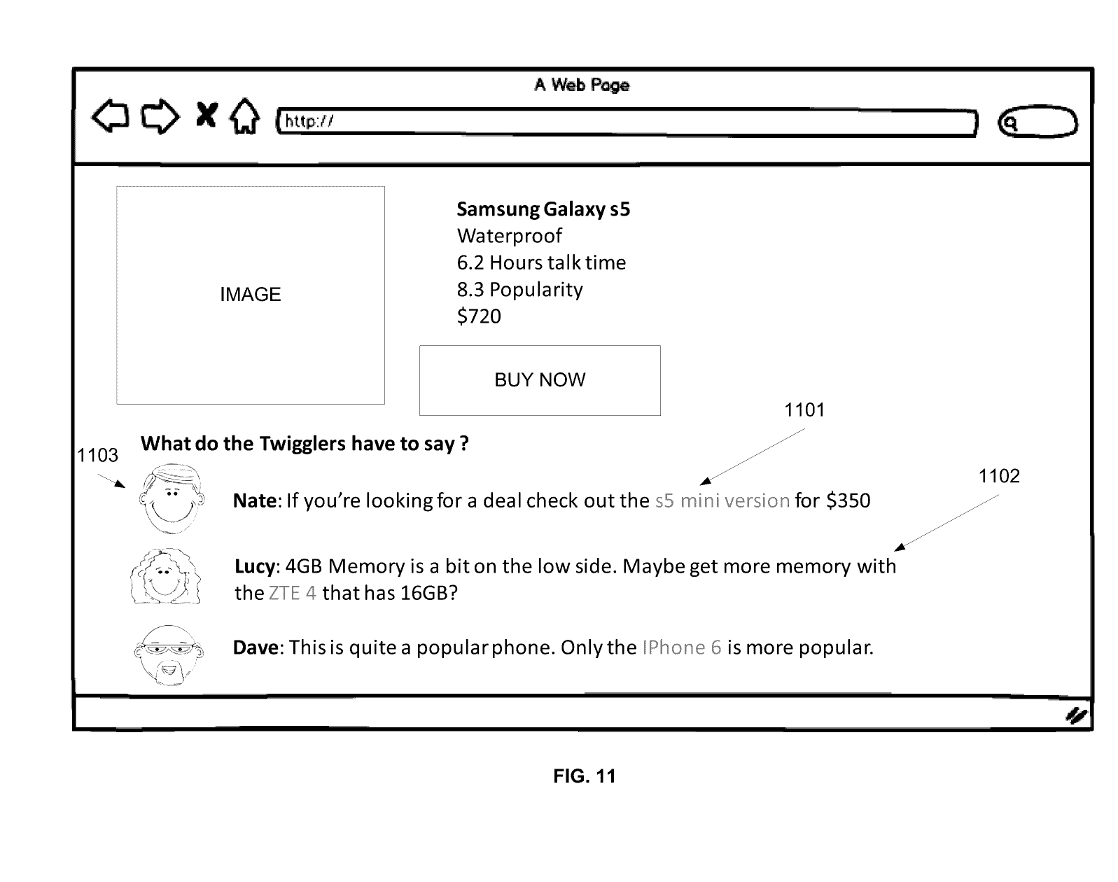

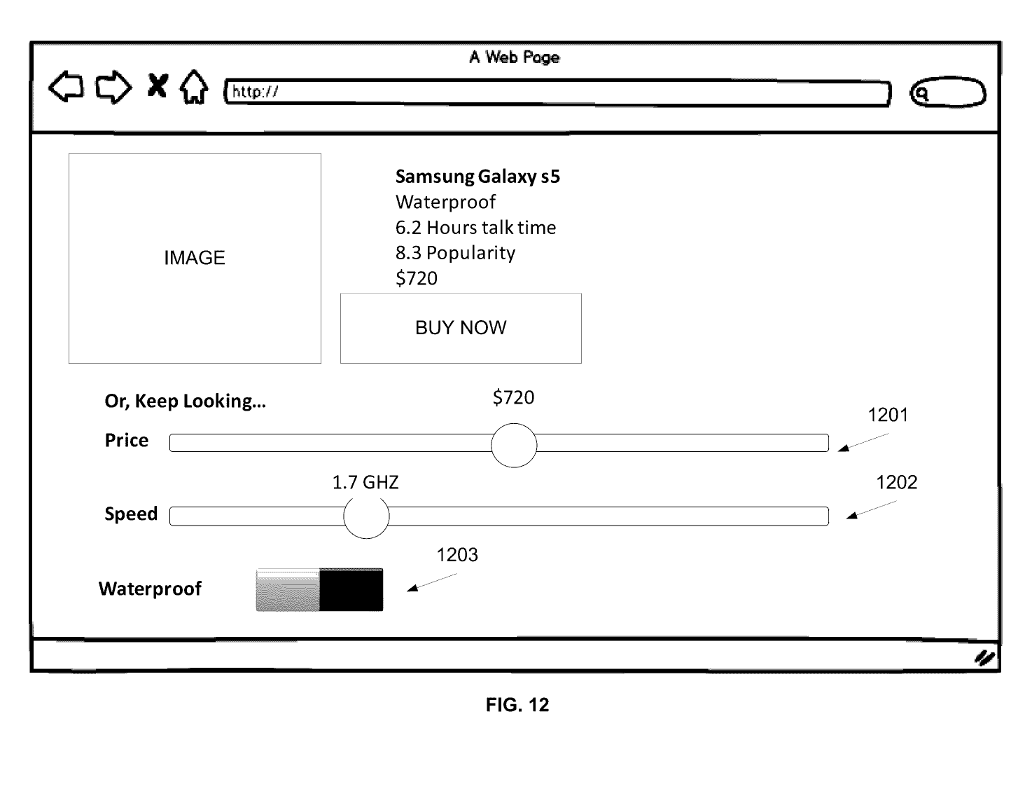

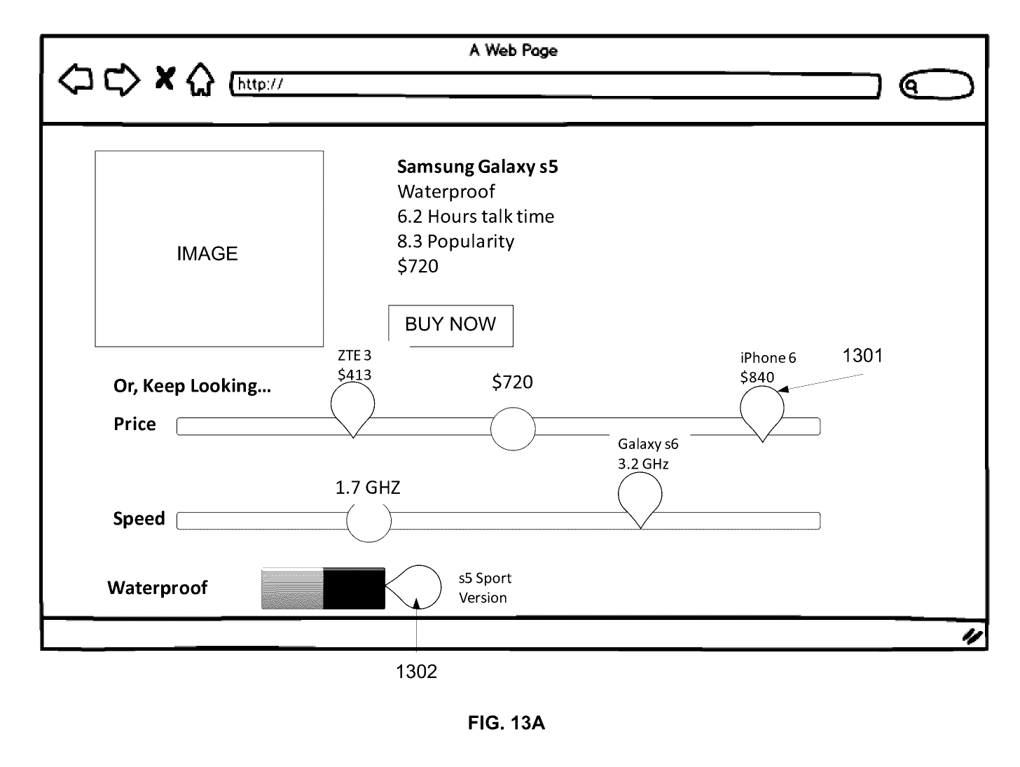

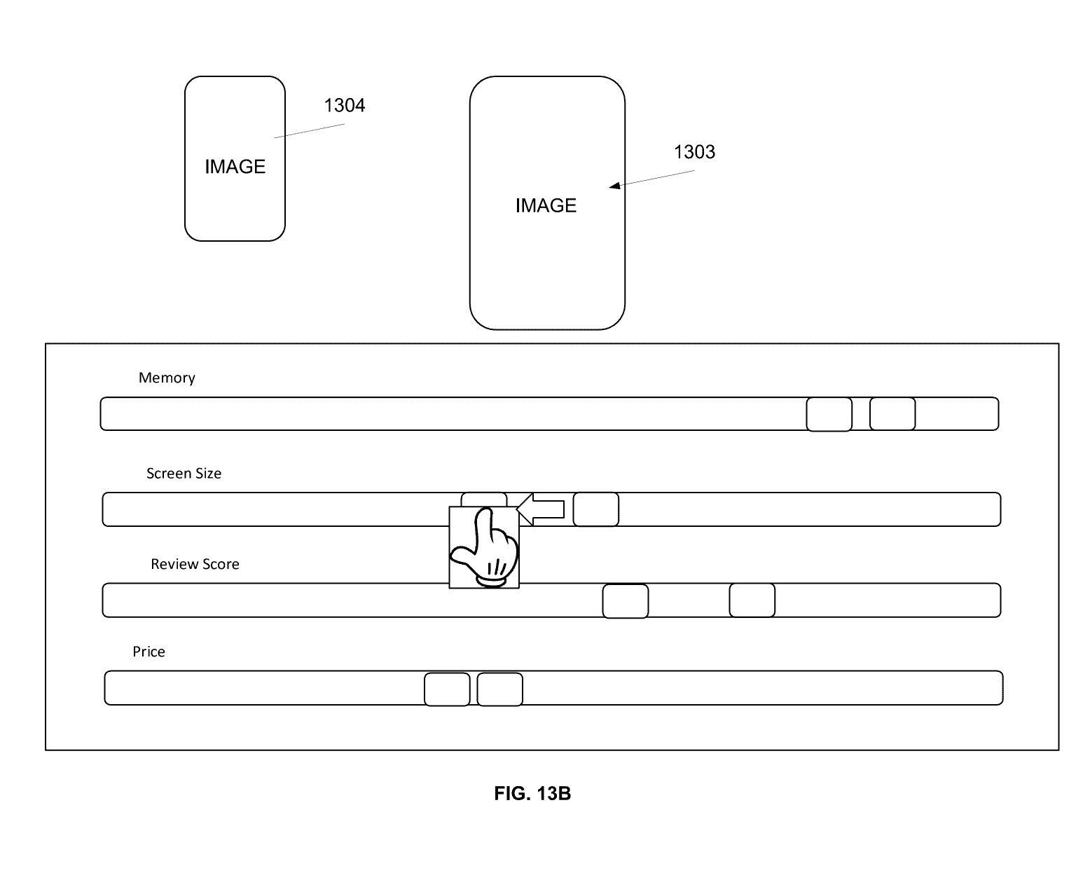

Another example is presented in FIG. 6A which is a schematic illustration of an exemplary interactive discovery UI wherein the interactive product navigation indications are images presented in a raw wherein reference products are indicated by text line and a selection of a text line triggers the addition of a new product to the raw. Each reference product characteristic leads to a selection of a new product as a currently selected product to allow repeating 104-107. The interactive product navigation indications may be along any other pattern, for instance along a curve as depicted in FIG. 6B. Optionally, the size of the interactive product navigation indications is reduced as a function of a distance of the respective characteristic value. For example, when a currently selected device has a screen of 4.1 inch, devices having different smaller size may be sequentially arranged thereafter, optionally in a decreasing size. Another example is presented in FIG. 6C which is a schematic illustration of an exemplary interactive discovery UI wherein the interactive product navigation indications are images presented in product characteristic clusters (e.g. each cluster as a raw of images) wherein each cluster includes products selected for the respective reference product characteristic. The interactive product navigation indications of each cluster may be along any other pattern.

Another example is presented in FIG. 7A which is a schematic illustration of an exemplary interactive discovery UI depicting a directed graph wherein the interactive product navigation indications are nodes connected to a node representing the currently selected product and a plurality of edges connecting the nodes are reference product characteristics. The directed graph is optionally iteratively generated by iteratively running 104-107 n iterations wherein in each one of the iterations nodes in a tier of the graph (with reference to the node representing the currently selected product) are identified and the respective reference product characteristics are used as edges. Selecting one of a new product indicated by one of the node marks the node as the currently selected product. Optionally, the relative size of the nodes changes. Optionally, nodes may be rearranged by drag and drop. This presentation reveals to the user more data from the similarity dataset 201.

FIG. 7B depicts another graph wherein nodes are products. In this graph edges are not direct; however, the size of the image depends on the tier distance from the currently selected product.

Another example is presented in FIG. 8 which is a schematic illustration of an exemplary interactive discovery UI wherein the interactive product navigation indications are text segments textually representing reference products. Each reference product characteristic leads to a selection of a new product as a currently selected product to allow repeating 104-107. An image of the currently selected product and icons representing its product characteristics are presented.

Another example is presented in FIG. 9 which is a schematic illustration of an exemplary interactive discovery UI wherein the currently selected product is presented as an image and descriptive text 900 and the interactive product navigation indications are images of new products identified by an iteration of 104-107. Each image is visually associated with the reference product characteristic for acquiring the depicted product, for instance as shown at 901. Optionally, a scroll down menu 902 or any other UI element allows the user to select additional reference product characteristics. Each reference product characteristic selection leads to a selection of a new product as the currently selected product to allow repeating 104-107. Optionally a UI element, such as a button 903 is presented to allow the user to purchase a presented product.

Another example is presented in FIG. 10 which is a schematic illustration of an exemplary interactive discovery UI wherein the currently selected product is presented as an image and descriptive text 1000 and the interactive product navigation indications 1001 are images of new products identified by an iteration of 104-107. Each image is visually associated with the reference product characteristic for acquiring the depicted product, for instance as shown at 1002. An interactive weight UI element, herein a pie chart 1004 depicting a weight of different product characteristics, is presented. In some embodiments, the interactive weight UI element may be replaced with any chart, graph or infographic element. Optionally, a selection of portion of the interactive weight UI element indicates that the respective product characteristic is important to the user. Such a selection may also be a reference product characteristic selection that leads to a selection of a new product as the currently selected product to allow repeating 104-107 with the selected product characteristic as a reference product characteristic. Optionally a UI element, such as a button 1003 is presented to allow the user to purchase a presented product.

Another example is presented in FIG. 11 which is a schematic illustration of an exemplary interactive discovery UI wherein the currently selected product is presented as an image and the interactive product navigation indications 1101 are text segments, for example words or sentences integrated into text sections and generated by an iteration of 104-107. Each text section describe the reference product characteristic for acquiring the textually indicated product, for instance as shown at 1102. An icon 1103 may represent a virtual human associated each text section. Optionally a UI element is presented to allow the user to purchase a presented product.

According to some embodiments of present invention the interactive product navigation indications of the interactive discovery UI are value control UIs, each associated with one reference product characteristic. For example, as shown in FIG. 12 is an exemplary interactive discovery UI. In FIG. 12 the value control UI is a slider emulating a knob or lever that is moved horizontally or vertically to control a variable of a reference product characteristic, such as price or speed, for instance as shown at 1201 and 1202. Optionally, as shown at 1203, binary values may be routed using a virtual toggle button. Each slider is visually associated with a text describing the reference product characteristic. When a user manipulates the value control UI, the value of the moving the reference product characteristic is changed, for example decreased or increased (not copied from the product characteristic values of the selected product but rather from the value control UI). This leads to identification of products having similar characteristic value.

Optionally, each manipulation of a value control UI leads to a selection of a new product as the currently selected product. Optionally, a manipulation of one value control UI may affect the other value control UI, for example brings a virtual knob of a slider to point to a value of a new product marked as a currently selected product.

Optionally, as shown at FIG. 13A, a number of products may be dynamically presented on the slider, see for example 1301, 1303. These products may be positioned by an analysis of the similarity dataset 201.

Optionally, as shown at FIG. 13B, a previously selected product may be presented after the slider is relocated, see for example 1304 that depicts an image of the previously selected product and 1303 that depict a currently selected product. These products may be positioned by an analysis of the similarity dataset 201.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a unit, a module, a server, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of product characteristics from other embodiments.

The word “optionally” is used herein to mean “is provided in some embodiments and not provided in other embodiments”. Any particular embodiment of the invention may include a plurality of “optional” product characteristics unless such product characteristics conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain product characteristics of the invention, which are, for clarity, described in the context of separate embodiments, may also be provided in combination in a single embodiment. Conversely, various product characteristics of the invention, which are, for brevity, described in the context of a single embodiment, may also be provided separately or in any suitable subcombination or as suitable in any other described embodiment of the invention. Certain product characteristics described in the context of various embodiments are not to be considered essential product characteristics of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for updating an interactive product navigation user interface, the system comprising:
a first interface for communicating with a client terminal used by a human user;
a program store storing a code; and
a processor coupled to said first interface and said program store for implementing the stored code, said code comprising:
code to perform a plurality of interface updating iterations, during each one of said plurality of interface updating iterations:
send instructions, via said first interface, to an application running on said client terminal to present an interactive product navigation user interface with an interactive indication;
receive a user selection of said interactive indication from said application;
select one of a plurality of products as a currently selected product according to said user selection;
receive at least one reference product characteristic from a plurality of product characteristics of said currently selected product;
update said interactive product navigation user interface with at least one new interactive indication of at least one recommended product selected from said plurality of products, said at least one recommended product is selected according to a similarity between a characteristic value of said at least one reference product characteristic of said currently selected product and a respective characteristic value of said at least one reference product characteristic of said at least one recommended product.

2. The system of claim 1, wherein said processor is adapted for implementing a code for deducing said at least one reference product characteristic from a search query submitted by said human user.

3. The system of claim 1, wherein said processor is adapted for implementing a code for deducing said currently selected product from a search query submitted by said human user.

4. The system of claim 1, further comprising a similarity dataset storing a plurality of characteristic values of said plurality of product characteristics of each of said plurality of products; wherein said processor is coupled to said similarity dataset; wherein said currently selected product is selected from an analysis of said similarity dataset.

5. The system of claim 4, wherein each one of said plurality of product characteristics having a marking as being a positive characteristic, a negative characteristic, or a neutral characteristic in said similarity dataset, wherein said at least one recommended product is selected according to said marking.

6. The system of claim 5, wherein said marking is deduced from sentiment analysis of a plurality of documents describing said plurality of product characteristics.

7. The system of claim 4, wherein said processor is adapted for implementing a mapping code comprising code to generate said similarity dataset by crawling in a plurality of web documents describing said plurality of products.

8. The system of claim 1, wherein said at least one recommended product is selected such that a plurality of characteristic values of a plurality of other product characteristics of said currently selected product and a respective plurality of characteristic values of said plurality of other product characteristics of said at least one recommended product are about the same.

9. The system of claim 6, wherein each one of said plurality of other product characteristics is associated with one of a plurality of weights used for selecting said at least one recommended product.

10. The system of claim 9, wherein at least some of said plurality of weights are determined according to a user characteristic of said human user.

11. The system of claim 9, wherein at least some of said plurality of weights are determined according to a prevalence of a respective characteristic value of said plurality of characteristic values among said plurality of products.

12. The system of claim 8, wherein said at least one recommended product is selected according to a ratio between an increment a value of said at least one reference product characteristic and a change to a plurality of characteristic values of said plurality of other product characteristics.

13. The system of claim 6, wherein each one of said plurality of other product characteristics is associated with one of a plurality of categories used for selecting said at least one recommended product.

14. The system of claim 1, wherein said interactive product navigation user interface comprises a plurality interactive indications including said interactive indication; wherein each one of said plurality interactive indications is associated with one of a plurality of reference product characteristics including said reference product characteristic; each one of said plurality interactive indications comprises a visual indication of one of said plurality of reference product characteristics.

15. The system of claim 1, wherein said at least one reference product characteristic comprises a plurality of reference product characteristics, at least some selected according to a type of said currently selected product.

16. The system of claim 1, wherein said at least one recommended product is selected so as to increase a variance coefficient among recommended products from said plurality of products which are associated with said plurality interactive indications.

17. The system of claim 1, wherein said at least one reference product characteristic is a user impression characteristic identified automatically by textual analysis of user uploaded content.

18. The system of claim 1, wherein said at least one reference product characteristic is a technical characteristic identified automatically by textual analysis of a plurality of product specifications.

19. The system of claim 1, wherein said at least one reference product characteristic is a User Usage characteristic identified by text analysis of a plurality of webpages.

20. The system of claim 1, wherein said at least one new interactive indication comprises at least one thumbnail of said at least one recommended product.

21. A method for updating an interactive product navigation user interface, comprising:
performing a plurality of interface updating iterations, during each one of said plurality of iterations:
send instructions to an application running on a client terminal to present an interactive product navigation user interface with an interactive indication;
receive a user selection of said interactive indication from said application;
select one of a plurality of products as a currently selected product according to said user selection;
receive at least one reference product characteristic from a plurality of product characteristics of said currently selected product;
update said interactive product navigation user interface with at least one new interactive indication of at least one member of at least one recommended product selected from said plurality of products, said at least one member is selected according to a similarity between a characteristic value of said reference product characteristic of said currently selected product and a respective characteristic value of said reference product characteristic of said at least one member.
